(19) United States
(12) Patent Application Publication
(10) Pub. No.: US 2007/0247715 A1
(43) Pub. Date: Oct. 25, 2007

(54) Projection illumination systems lenses with diffractive optical elements

(76) Inventor: Melvin Francis, Morrison, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 11/409,506

(22) Filed: Apr. 21, 2006

(51) Int. Cl. G02B 5/18

(52) U.S. Cl. 359/566; 359/554

(57) ABSTRACT

An optical assembly for a projection illumination system has a refractive lenses and a diffractive lens for imaging a sheet of light from a light source onto a Spatial Light Modulator (SLM). One embodiment utilizes a fresnel lens having kinoforms formed on a surface. Such a lens may be molded using a light-weight plastic in a single step.

### BACKGROUND OF THE INVENTION

1. Field of the Invention

This invention relates to illumination systems utilizing diffraction pattern-forming lenses. In particular, this invention relates to illumination systems in projection displays wherein lenses based on refraction at least partially have been replaced with diffractive optical elements.

2. Description of Related Art

FIG. 1 (Prior Art) shows a conventional projection display 100. Such a system may be used for a front or rear projection system or the like. An example of a well known application is the television.

Lamp 102 provides light which is integrated by integrator 104. Integrator 104 is, for example, a hollow path formed by four inward facing mirrors. Light from lamp 102 bounces off the mirrors many times, so that a uniform rectangular field of light is formed at the exit of integrator 104. Color filters 106 are designed to provide the correct color of light when Spatial Light Modulator (SLM) 118 is set to program that color. Illumination lenses 108 are, for example, three glass aspherical lenses 108-L1, 108-L2, and 108-L3 as shown in FIG. 2 (Prior art).

Illuminations lenses 108 act to project the uniform field at the output of integrator 104 onto the SLM 118, via prism 110. The spatially modulated light is then provided to projection lens 114.

This system works well, but has several disadvantages. First, the aspherical glass lenses are heavy and bulky, and expensive to fabricate. Second, such systems are prone to chromatic aberrations, because the lenses have different focal lengths for different wavelengths of the light. These means that the uniform field generated by integrator 104 becomes non-uniform in size and color by the time it reaches SLM 118.

A need remains in the art for a more inexpensive illumination system for projectors. In Addition there is the need for such inexpensive illumination systems with improved chromatic performance.

### SUMMARY

According to one aspect of the present invention it is an object to provide a more inexpensive illumination system for projectors This is accomplished by replacing the aspherical glass lenses of an illumination system with lenses which are less heavy, less bulky and less expensive in production. Examples of such alternative lenses are refractive fresnel lenses. They comprise a certain number of ring shaped fresnel zones. Within these zones the shape of the fresnel lens follows the shape of the conventional refractive lens. However from zone to zone there is a discontinuity which allows to reduce the overall thickness of the lens as compared to a conventional refractive lens.

Unfortunately such fresnel lenses exhibit the effect of chromatic aberrations. According to another aspect of the present invention it is therefore an object to provide such an illumination system with improved chromatic performance.

One major effect which influences the chromatic performance of lenses is the dispersion of the lens material. Typically the index of refraction decreases with increasing wavelength of light. Refraction can be described by Snell's law:
n₁ sin α=n₂ sin β

The focal length of a practical convex or planoconvex lens is therefore shorter for blue light as compared to the focal length for red light. This is true for the classical overall continuous relief lenses as well as for refractive fresnel lenses.

In this context it is interesting that diffractive optical elements show a very different dispersion behavior. Diffraction occurs when two or more spatially separated beams are coherently combined and interfere either constructively or destructively. This leads to the so called diffraction pattern. As is clear spatial coherence here plays an important role. Therefore, features of such diffractive optical elements need to be small enough in order to combine beams within the spatial coherence. The most prominent among the diffractive optical elements is the diffraction grating. The angles of the diffraction orders are ruled by the diffraction equation:

$${n}_{1} sin α - {n}_{2} sin β = m \frac{λ}{Λ}$$

where n₁ and n₂ are the indexes of the surrounding media, m is an integer, λ is the wavelength and Λ is the grating period. If the surrounding media are air n1 and n2 are equal to one. From the grating equation it can be seen that diffraction orders of blue light lead to smaller diffraction angles as compared to red light.

As explained before the trick of introducing discontinuities into the lens allows reduction of the thickness of a lens dramatically. The result is a fresnel lens comprising several ring shaped fresnel zones. The size of the fresnel zones decreases the more the thickness of the lens is reduced. If the size of the zones is reduced below the spatial coherence of the light used for illumination, diffraction effects become prominent. In this case the term diffractive fresnel lens is used. For fresnel lenses the outer zones have the minimum size. In order to classify the fresnel lenses for the purpose of this description the term “refractive fresnel lens” is used for lenses with minimum zone sizes which are equal or above 200 μm. In contrast the term “diffractive fresnel lens” is used for lenses with minimum zones sizes which are below 200 μm.

Related to the different manufacturing processes there are different realizations of diffractive fresnel lenses. If within the zone of a diffractive fresnel lens the profile is continuous relief the term “kinoform” is used. However the profile within a zone could be as well discontinuous, leading to a stepped binary or multilevel diffractive fresnel lens.

According to one aspect of the present invention improved chromatic performance can be achieved in an illumination system if a refractive lens, preferably a refractive fresnel lens is combined with a diffractive optical elements, preferably with a diffractive fresnel lens, where material dispersion and dispersion due to diffraction compensate at least approximately for each other.

Refractive lens and diffractive fresnel lens could be realized on separated substrates. However according to another aspect of the present invention the diffractive fresnel lens is preferably integrated on the surface of one of the refractive lenses of the illumination system.

Such lenses could be realized with plastic substrates. They are thin and light weight, and easy to manufacture.

### BRIEF DESCRIPTION OF THE DRAWINGS

FIG. 1 (Prior Art) is block diagram of a projection device using a conventional illumination system.

FIG. 2 (prior art) is side view of the lenses forming the conventional illumination system of FIG. 1.

FIG. 3 is a side view of lenses forming a first embodiment of the illumination system optics according to the present invention.

FIG. 4 is a side isometric view of a projection system utilizing the illumination system optics of FIG. 3.

FIGS. 5A through 5C show back, side, and front views, respectively of one of the lenses of FIG. 3.

FIGS. 6A and 6B show a first embodiment of a lens of FIG. 3, exaggerated for detail.

FIGS. 7A and 7B show a second embodiment of a lens of FIG. 3, exaggerated for detail.

FIGS. 8A and 8B show a third embodiment of a lens of FIG. 3, exaggerated for detail.

### DETAILED DESCRIPTION OF THE PREFERRED EMBODIMENTS

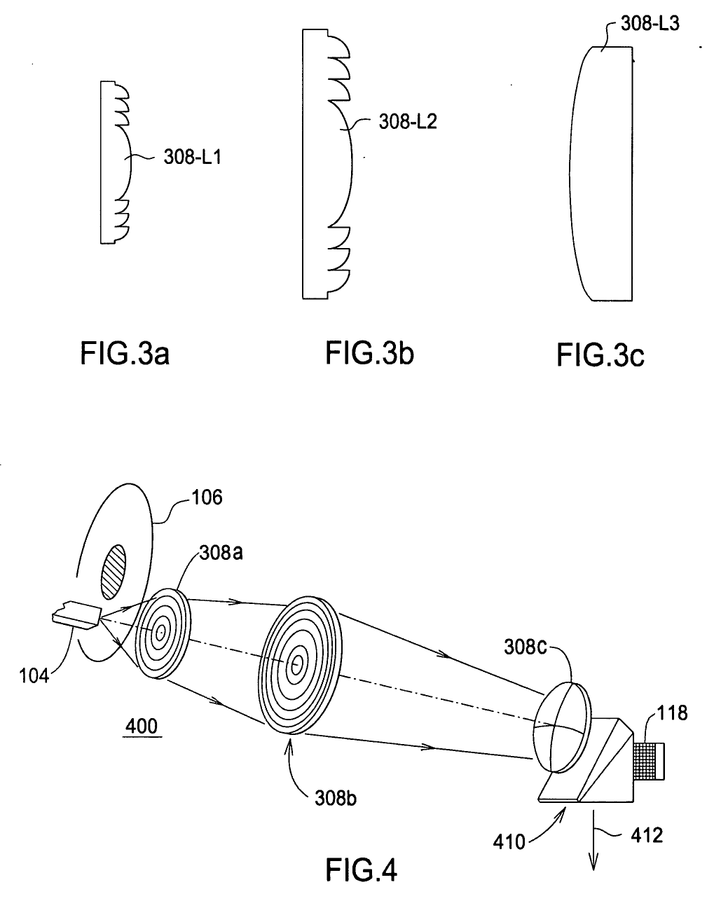

FIG. 3 is a side view of lenses 308-L1, 308-L2, and 308-L3 forming a first embodiment of the illumination system optics according to the present invention. In this particular embodiment, lens 308-L1 is a refractive fresnel lens and lens 308-L2 is a lens which comprises a refractive as well as a diffractive fresnel lens, while lens 308-L3 is a conventional refractive lens. FIG. 3 does not show that lens 308-L2 includes a surface with a diffractive fresnel lens used to correct for chromatic aberrations. This is shown in FIGS. 6-8. In the example of FIGS. 6-8 the diffractive fresnel lens is a kinoform. This combination has been shown to work well, but many variations are possible. For example, all three lenses could comprise refractive fresnel lenses (or conventional lenses). More than one of the lenses could include such a diffractive optical element.

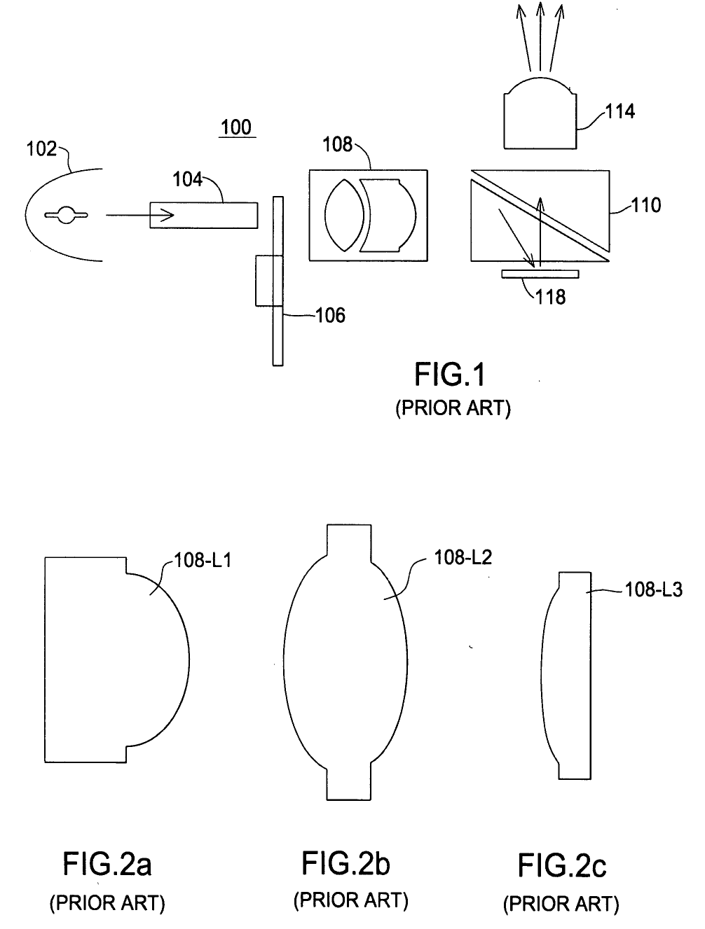

FIG. 4 is a side isometric view of a projection system 400 utilizing the illumination system optics of FIG. 3. This system is somewhat similar to that of FIG. 1, and similar elements have similar reference numbers. Light integrator 104 provides uniform light to color filter 106, in this case a filter wheel. Lenses 308a and 308b are fresnel lenses, and lens 308c is a conventional aspheric lens.

Prism assembly 410 allows light to pass through from lens 308c to Spatial Light Modulator (SLM) 118. SLM 118 might be, for example, a MEMS device having a plurality of mirrors which can be individually turned on or off (via angle variations). The mirrors which are turned on then reflect light at an angle such that it is totally internally reflected within prism 410, and modulated light 412 is provided to projection lens 114 (see FIG. 1 Light from mirrors which are rotated into the off position is not totally internally reflected, and is, for example, transmitted out of the top of prism 410 and removed. Or, SLM 118 might comprise an LCD.

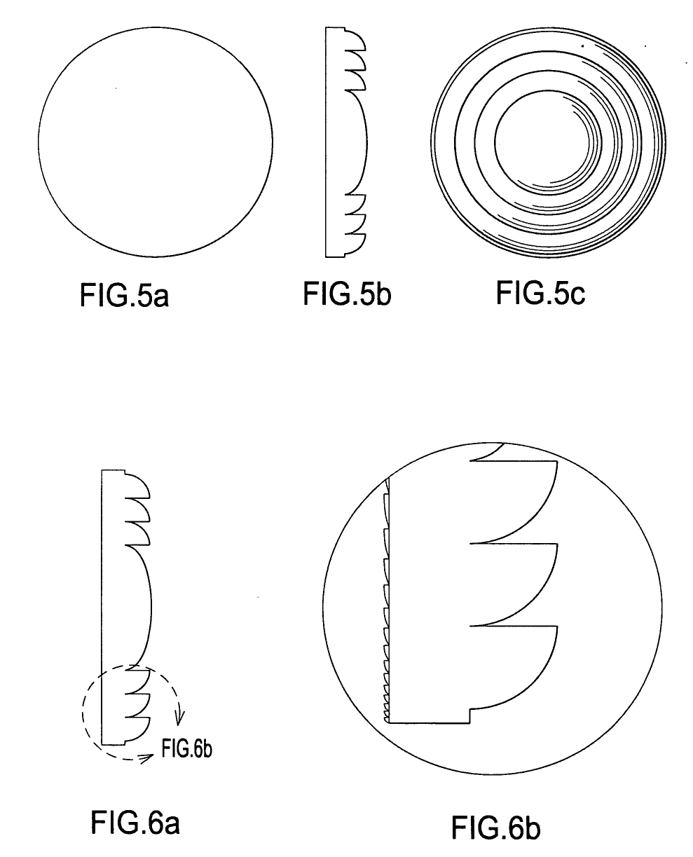

FIGS. 5A through 5C show back, side, and front views, respectively of an embodiment of one of the lenses of FIG. 3, exaggerated to show the fresnel rings. Either lens 308-L1 or 308-L2 are depicted here, as the kinoforms are not visible unless much further exaggerated (see FIGS. 6-8). FIG. 5A shows the back of the lens, and hence looks like a disk. FIG. 5B is a side cutaway view, which illustrates the (exaggerated) fresnel ring profile. FIG. 5C is a front view, which shows the fresnel rings.

FIGS. 6A and 6B show a first embodiment of lens 308-L1, exaggerated for detail. FIG. 6 is a side cutaway view of the lens, and FIG. 6B is a blow up of a portion of FIG. 6A. FIG. 6A looks exactly like FIG. 5B, and the kinoforms are not visible. FIG. 6B shows the kinoforms on the flat back surface of lens. Note again that both the fresnel pattern and the kinoforms are greatly exaggerated, for clarity.

As a design example we start with a parabolic planoconvex lens. The convexity of this lens may be described by the formula D_{F}(r)=10 mm−4/90*r² where r is the radial distance to the center of the lens. This leads to a lens of diameter of 30 mm. The lens is transformed to a fresnel lens: Moving from the perimeter to the center, whenever the thickness exceeds 1 mm a discontinuity is introduced and the thickness is reduced to zero, starting a new zone. The locations of these discontinuities are described by the formula

$${R}_{N} = \frac{3}{2} mm * \sqrt{10 N} .$$

As can be seen, this lens with 30 mm diameter comprises 10 fresnel rings. N=1 belongs to the center “ring,” which itself is not a ring but a lens shaped circular area. This inner zone has a radius of R₁≈4.74 mm. The outermost zone has a width of ΔR=R₁₀−R₉≈0.77 mm. From this it can be clearly seen that this fresnel lens is still a refractive lens and diffraction effects will not play an important role.

The design procedure for the kinoforms is very similar: We start again from a planoconvex lens. The convexity of this lens may be described by the formula D_{K}(r)=0.580 mm−(0.580/225 mm)*r² where r is the radial distance to the center of the lens. Again this leads to a lens of diameter of 30 mm. This lens is transformed to a kinoform by: Starting form r=15 mm and approaching the center, whenever the thickness exceeds 1 μm a discontinuity is introduced and 20 the thickness is reduced to zero, starting a new zone. The locations of these discontinuities are described by the formula

$${R}_{N} = 15 mm * \sqrt{\frac{1 μ m}{580 μ m} N} .$$

As can be seen this lens with 30 mm diameter comprises 580 fresnel rings. The inner zone has a width of R₁≈623 μm. The outermost zone has a width of ΔR₅₈₀≈13 μm.

From this it can be seen that this fresnel lens is a diffractive lens and diffraction effects play a major role.

These two elements could be brought into the illumination path separately. However according to one aspect of the invention the elements are realized on the same substrate. Such a substrate might be a disc shaped plastic substrate. It is possible to realize the refractive fresnel lens on one side of the disc shaped plastic substrate and the kinoform on the other side of the disc shaped plastic substrate. Another possibility is to integrate the kinoform structures directly on the profile of the refractive fresnel lens and to leave the other side of the disc plane and for example provide for antireflection means in order to minimize optical loss.

The lens 308-L1 of the embodiment according to FIG. 6 has on one side a fresnel lens with a profile as described above. The other plane side is replaced by the kinoform as described above.

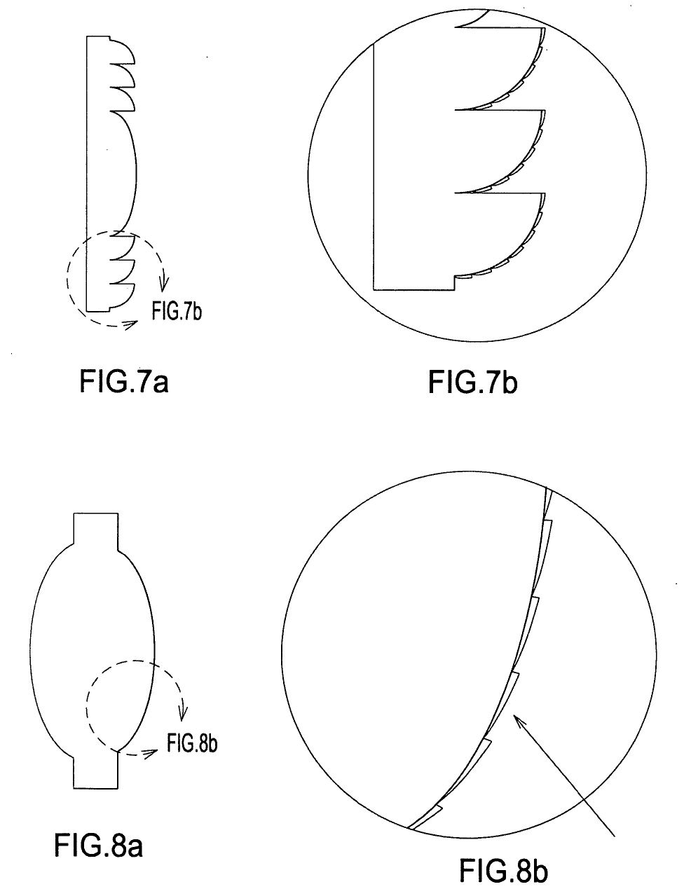

FIGS. 7A and B show a second embodiment of lens 308-L1. Again, FIG. 7B is blown up from a portion of FIG. 7A, and greatly exaggerated for detail. This embodiment is similar to that of FIGS. 6A and 6B, except that the kinoforms are formed on top of the fresnel structure.

A prototype version of this embodiment was fabricated by diamond turning the plastic lens on a special lathe which carved the plastic. In commercial fabrication, a similar process could be used, but to form a mold which would then be used to form the lenses.

FIGS. 8A and 8B show a third embodiment, which is a variation of lens 308-L1. Again, FIG. 8B is blown up from a portion of FIG. 8A, and greatly exaggerated for detail. The embodiment of FIGS. 8A and 8B is based on a conventional lens, rather than a fresnel lens, and has the kinoforms formed on the curved surface of the lens. As an alternative, kinoforms could be formed on a flat surface of a conventional lens having a flat surface.

The embodiment of FIGS. 8A and 8B sacrifices the light weight and size of a fresnel lens, but maintains the color performance provided by the kinoforms. Hence it is useful in some configurations.

It will be appreciated by one versed in the art that there are many possible variations on these designs. Some known and anticipated variations are described below:

Any lens which results in the desired diffraction as produced by the specific embodiments described above is encompassed within the present invention. The specific embodiments have attractive features, such as low cost and convenient fabrication, but the core of the invention is the diffraction pattern produced by the diffractive lenses. Hence a lens with a hologram formed on one surface that produced such a diffraction pattern would be an alternative. Or, the diffraction pattern could be produced by etching the lens, to produce a stepped binary or multilevel pattern that approximates the continuous profile and acts similarly to kinoforms.

Not much emphasis has been given throughout this description to describe how the actual design data of the refractive and diffractive lenses were found. The reason for this is that excellent design tools (for example Zemax or ASAP) are available and the one skilled in the art with this description in hand will know how to simulate, vary and finally choose the design parameters to realize optimum results for a specific illumination system.

In the case where the lens 408b is a plastic lens comprising both fresnel patterns and kinoforms, one commercially available plastic that has been shown to work well is Zeonex™ E48R. Alternatively, acrylic or polycarbonate could be used.

What is claimed is:

1. An optical assembly for a projection illumination system comprising:
optical elements for imaging a sheet of light from a light source onto a Spatial Light Modulator (SLM);
wherein at least one of the optical elements comprises a refractive lens and
wherein at least one of the optical elements comprises a diffractive lens, the diffractive lens comprising structures smaller than 200 μm.

2. The apparatus of claim 1 wherein the refractive lens is a fresnel lens

3. The apparatus according to one of the claims 1 and 2 wherein the diffractive lens comprises a kinoform.

4. The apparatus of claim 1 wherein the diffractive lens and the refractive lens are realized on the same substrate.

5. The apparatus of claim 1 wherein the diffractive is realized on a first side of the substrate and the refractive lens is realized on a second side of the substrate.

6. The apparatus of claim 4 wherein the surface of the diffractive lens is integrated on the lens forming surface of the refractive lens.

7. The apparatus of claim 3 wherein the diffraction pattern-forming lens is molded.

8. The apparatus of claim 3 wherein the kinoforms are formed on the surface on which the fresnel patterns are formed.

9. The apparatus of claim 3 wherein the kinoforms are formed on the opposite surface from the surface on which the fresnel patterns are formed.
